(19) United States
(12) Patent Application Publication
(10) Pub. No.: US 2008/0025497 A1
(43) Pub. Date: Jan. 31, 2008

(54) Multiple key encryption with "Red Herrings"

(76) Inventor: Mark Ellery Ogram, Tucson, AZ (US)

Correspondence Address: Mark E. Ogram, 7454 E. Broadway # 203, Tucson, AZ, 85710, US

(21) Appl. No.: 11/592,677

(22) Filed: Nov. 3, 2006

Related U.S. Application Data
(63) Continuation-in-part of application No. 11/170,229, filed on Jun. 28, 2005.

(51) Int. Cl. H04L 9/28

(52) U.S. Cl. 380/28

(57) ABSTRACT

An encryption and communication system and computer which creates a message having both true encrypted characters with false (Red Herring) characters intermixed therewith. In one embodiment, a template is created which is then communicated to a remote computer. The message to be encrypted is received and the placement of the false information (acting as Red Herrings) is established and placed within the template. The true encrypted characters are then placed within the template without disturbing the false characters.

This is a continuation-in-part of U.S. patent application Ser. No. 11/170,229, filed on Jun. 28, 2005, and entitled “Encrypted Communications”.

### BACKGROUND OF THE INVENTION

This invention relates generally to the communication of data and more particularly to communications which are encrypted.

A variety of techniques have been developed which encrypt messages. These include: U.S. Pat. No. 7,117,526, issued on Oct. 3, 2006, to Short and entitled “Method and Apparatus for Establishing Dynamic Tunnel Access Sessions in a Communication Network”; U.S. Pat. No. 7,117,517, issued on Oct. 3, 2006, to Milazzo et al. and entitled “Method and Apparatus for Generating Data Structures for a Hyperlinked Television Broadcast”; U.S. Pat. No. 7,117,504, issued on Oct. 3, 2006, to Smith et al. and entitled “Application Program Interface that Enables Communication for a Network Software Platform”; U.S. Pat. No. 7,117,495, issued Oct. 3, 2006, to Blaser et al. and entitled “Systems and Methods for the Creation of Software Packages Using Layered Systems”; U.S. Pat. No. 7,117,493, issued Oct. 3, 2006, to Matsushima and entitled “Image Formation System, Software Acquisition Method and Computer Product”; U.S. Pat. No. 7,117,485, issued Oct. 3, 2006, to Wilkinson et al. and entitled “Using a High Level Programming Language with a Microcontroller”; U.S. Pat. No. 7,117,376, issued Oct. 3, 2006, to Grawrock and entitled “Platform and Method of Creating a Secure Boot that Enforces Proper User Authentication and Enforces Hardware Configurations”; U.S. Pat. No. 7,117,374, issued Oct. 3, 2006, to Hill et al. and entitled “Apparatus and Method for Gathering and Utilizing Data”; U.S. Pat. No. 7,117,373, issued Oct. 3, 2006, to Trimberger et al. and entitled “Bitstream for Configuring a PLD with Encrypted Design Data”; U.S. Pat. No. 7,117,372, issued Oct. 3, 2006, to Trimberger et al. and entitled “Programmable Logic Device with Decryption and Structure for Preventing Design Relocation”; U.S. Pat. No. 7,117,371, issued Oct. 3, 2006, to Parthasarathy et al. and entitled “Shared Names”; U.S. Pat. No. 7,117,370, issued Oct. 3, 2006, to Khan et al. and entitled “System for Transmitting Secure Data between a Sender and a Recipient over a Computer Network using a Virtual Envelope and Method for using the same”; U.S. Pat. No. 7,117,369, issued Oct. 3, 2006, to Burns et al. and entitled “Portable Smart Card Secured Memory System for Porting User Profiles and Documents”; U.S. Pat. No. 7,117,366, issued Oct. 3, 2006, to Vincent and entitled “Public Key Based Authentication Method for Transaction Delegation in Service-Based Computing Environments”; U.S. Pat. No. 7,117,365, on Oct. 3, 2006, to Rump et al. and entitled “Method and Device for Generating a Data Stream and Method and Device for Playing Back a Data Stream”; U.S. Pat. No. 7,117,364, on Oct. 3, 2006, to Hepper et al. and entitled “System and Method for Downloading Application Components to a Chipcard”; U.S. Pat. No. 7,117,363, issued Oct. 3, 2006, to Lincoln et al. and entitled “System and Method using Information-Based Indicia for Securing and Authenticating Transactions”; U.S. Pat. No. 7,117,362, issued Oct. 3, 2006, to Go et al. and entitled “Information Providing Apparatus and Method, Information Processing Apparatus and Method, and Program Storage Medium”; U.S. Pat. No. 7,117,359, issued Oct. 3, 2006, to Wood et al. and entitled “Default Credential Provisioning”; U.S. Pat. No. 7,117,357, issued Oct. 3, 2006, to Bade and entitled “Method, System, and Product for Pre-Encrypting Static Information Transmitted by Secure Web Sites”; and, U.S. Pat. No. 7,117,266, issued Oct. 3, 2006, to Fishman et al. and entitled “Method for Providing User-Apprarent Consistency in a Wireless Device”, all of which are incorporated hereinto by reference.

While distributed network systems such as the Internet, have expanded the horizons for the world in the collection and dissemination of knowledge, by the very nature of these systems, there has developed a growing awareness that information which is so easily obtained, is also lost with the same ease. The problems and crimes associated with the broad dissemination of information have become common place occurrences, and the problems are only expected to become more pronounce in the future.

These problems include such things as: identity theft; credit card theft; hacking into private data-bases; disrupting private computers through “viruses”; disruption of governmental data bases; fraudulent control of traffic systems; and many more.

Central to all of these problems is the intrinsic anonymous nature of the communications. A receiver of information receives only bits/bytes of digital information and the source of such digital information is generally unknown. Within the Internet, identities are easily created.

In an attempt to provide some level of knowledge of the other side, passwords and ID's (identification values/symbols) are often used. Unfortunately, often these passwords/IDs are stolen and are then used indiscriminately by a criminal or hacker.

Another technique which has been used to curtail the improper gathers of information is the creation of encryption techniques such as the iKP protocol. These protection schemes though attempt to develop a standard encryption methodology which is used for every secure transmission, but this requirement in and of itself tends to make the encryption both difficult in use and in storing.

Almost by the very nature of encryption, encryption must be complex. The Enigma Machine developed by Germany during World War II was an elaborate and complex systems of gears which was used to map each new character and which relied upon the previously mapped message in determining how the next character was mapped.

While there is a natural tendency to use “complex” solutions, these complexities make the use of the solution difficult if not impossible.

It is clear there is a need for an efficient and individualized communication channel.

### SUMMARY OF THE INVENTION

A communications system in which a sending computer encrypts a message using a key associated with the computer which is to receive the message; the receiving computer uses a key associated with the sending computer in the decryption process.

In the preferred embodiment, the sending computer is equipped with a set of keys and each key within the set is useable for the encryption process. The selection of a particular key depends on the destination of the message; or, if it is the first time a message is being sent to that destination, the key is arbitrarily selected and a record associated the arbitrarily selected key and the destination is made for future reference.

While the present discussion refers to “computer”, the invention is not intended to apply solely to a single or stand-alone computer. Rather, the term “computer” is intended to relate to a single computer as well as a system of computers which work in concert to obtain the objectives outlined.

The following discussion recognizes that a computer is configured to perform a designated operation on data to obtain a desired result. Configuration of a computer is often done through a programming language (e.g. assembly, basic, Colbol, Fortran, C.) which defines the function of the computer; but, in some situations, “hard wired” or dedicated circuitry is also used.

Within the present discussion, the invention relates to a sequence of symbols which are represented in a digital manner. Those of ordinary skill in the art readily recognize a variety of such sequences such as the American Standard Code for Information Interchange (ASCII). In some situations, the digital map to symbols is arbitrarily done. In this case, each symbol is arbitrarily assigned a unique value which forms another level of encryption.

The present discussion refers to the Internet, but, the invention is not intended to be so limited and is viable for any distributed network of computers.

For ease in reference, some many of the terms used herein, such as “computers”, “keys”, “data”, “messages” and the like, have been given labels (such as first, second third or primary, secondary, etc.) to help identify them; but, these labels are not intended to be limiting as to the order of use, ownership, or physical position.

Within this invention, each “computer” is defined by its capabilities or function.

Within the present invention, each digital value which is to be communicated, is mapped uniquely to another value within the field. In this manner, the mapping or encrypting is done on an individual value without any necessary reference to prior or future encryptions. To accomplish this unique mapping objective, the encrypting site and the decrypting site both have a “key” which is used both for the encrypting and decrypting operation. Since the “key” or mapping template provides a unique mapping and that “key” is not available to others, the possibility of a “hacker” being able to fraudulently decrypt the message is all but eliminated.

In this context, the “key” is a series of values which are used in both the mapping process and the reverse-mapping process and consists of a series Sⱼ.

The creation of the key is accomplished through a variety techniques, including, but not limited to: random number generation, prior data based, fixed set, historically based, based on the computer identification/serial number, or any combination of the above.

Random number based keys are created using a programmed or “canned” random number generator. These generators produce a series of values which appear random, but, in actuality are not truly random in that each time the random number generator program is initiated, it produces an identical series of “random numbers”; hence, if the encrypting and the decrypting computers operate the same random number generator, both computers develop identical series of values.

An alternative technique creates a series of numbers to create the key using values from the message or the key itself which have been produced or provided earlier. In this case, a Markov type of series is produced. The creation of the function which produces this series of values is limitless and relies only upon the creative power of the developer. As example, the following are all possible functions:

| | | |
|---|---|---|
| Sⱼ = 3*Sⱼ₋₁ + 2*Sⱼ₋₂ + Sⱼ₋₃ | OR | Sⱼ = 3*Oⱼ₋₁ + 2*Oⱼ₋₂ + Oⱼ₋₃ |
| Sⱼ = Abs(3*Sⱼ₋₁ − (Sⱼ₋₂ + Sⱼ₋₃)²) | | Sⱼ = Abs(3*Oⱼ₋₁ − (Oⱼ₋₂ + Oⱼ₋₃)²) |
| Sⱼ = Sⱼ₋₁ + Sⱼ₋₂ + Sⱼ₋₃ | | Sⱼ = Oⱼ₋₁ + Oⱼ₋₂ + Oⱼ₋₃ |
| Sⱼ = Sⱼ₋₁ + 2 | | Sⱼ = Oⱼ₋₁ + 2 |
| Sⱼ = 2*Sⱼ₋₂ + 5 | | Sⱼ = 2*Oⱼ₋₂ + 5 |

(Note,
within this discussion, “*“ denotes multiplication; “ABS” denotes absolute value)

A fixed set is any sequence of values. Ideally these values should not have any readily discernable relationship or patter, making hacking the message even more difficult. When a fixed set is used, both the encrypting and the decrypting computer ideally have the fixed set within their own memory. Again, the number of sets which can be used are only limited by the creativity of the developer of such sets. Examples of such sets include:
Set 1 3, 6, 9, 32, 55, 43, 29, 23, 5, 13, 19, 91, 28, 21, 23, 11, 19, 100, 43, 56, 59, 132, 255, 1143, 2329, 623, 65, 613, 919, 91, 128, 421, 823, 711, 19, 0
Set 2 2, 4, 7, 4, 9, 3, 6, 1, 9, 6, 6, 8, 5, 4

Note, the length of the fixed set isn't critical to the process as the set can be extended to any required length (to fit the message itself) by simply repeating the fixed set, reversing its order, skipping values when repeating the set, etc. Those of ordinary skill in the art readily recognize a variety of different techniques which allow the fixed set's length to be extended.

Also note, the values within the key are not limited to a particular range; although some embodiments do limit the values to a set range for ease in computation.

A “key” is possible using historical data. In this method, each new message is used to establish a new “key”. As example, if the message was, “The red dog ran home”, then these values will be used as the key for the second message; and the second message will act as a “key” for the third message; etc.

A “key” can also be made using the computer's own identification. Such fixed values include the serial numbers of the computers involved and/or the e-mail identifier for the computers. Those of ordinary skill in the art readily recognize a variety of techniques which serve this function. As example, assume the computer's serial number is: AJX45812, then a potential initial key is (assigning numerical values to the letters):
27 36 40 4 5 5 8 1 2
   with a subsequent set being defined as the value in the first set added to the next occurring value:
63 76 44 9 13 9 29
   This technique can be repeated as many times as is necessary to provide mapping values for the length of the message being received.

Even further, some “keys” are created using combinations of the above.

For purposes of description, the following are used as the mathematical basis for the preferred embodiment of the invention.
N denotes the number of symbols or characters within the communication;
Oⱼ denotes the original value for the Jth position in the message, J=1, N;
MSG denotes the communication produced by the series Oⱼ, J=1, N;
Sᵢ denotes the adjustment value for the Jth position in the message, J=1, N;
K The key sequence denoted by the series Sⱼ, J=1, N;
Eⱼ denotes the encrypted value for the Jth position in the message, J=1,N; While the preferred embodiment place a range for Eⱼ to fall within the range of Oⱼ, other embodiments do not have this requirement;
M(A,B) denotes the mapping function Eⱼ=M(Oⱼ, Sⱼ), J=1, N, where M is the function that maps the original value Oⱼ using an adjustment value Sⱼ to get the encrypted value Eⱼ;
M′(A,B) denotes a converse map Oⱼ=M′(Eⱼ, Sⱼ), J=1, N which maps the encrypted valued Eⱼ, using the adjustment value Sⱼ to recreate the original message Oⱼ;
Xⱼ denotes the maximum numerical value for Oⱼ; (often this value is fixed for the entire message but in some situations, the maximum value changes during the message);
R(A,B) This function returns the whole number remainder value when A is divided by B (this function is used within the preferred embodiment for the mapping operation).

Using the above references, the preferred embodiment uses a mapping function as indicated:
Eⱼ=M(Oⱼ,Sⱼ)=R[Oⱼ+R(Sⱼ,Xⱼ),Xⱼ]

Those of ordinary skill in the art readily recognize a variety of other relationships which serve as mapping using the above structures. Examples of these types of mapping are:
Eⱼ=M(Oⱼ,Sⱼ)=R[Oⱼ*Sⱼ,Xⱼ]
Eⱼ=M(Oⱼ,Sⱼ)=R[Oⱼ+2*Sⱼ,Xⱼ]
Eⱼ=M(Oⱼ,Sⱼ)=R[Oⱼ+Sⱼ+Sⱼ₋₁,Xⱼ]

Further, those of ordinary skill in the art readily recognize alternative mapping functions that are useable in the context described herein.

In one embodiment of the invention, an encryption and communication system is created. This embodiment of the invention significantly enhances an encryption methodology, whether that methodology is the one outlined above or any other well known to those of ordinary skill in the art.

Whereas, in the past, a single symbol or word is encrypted into another symbol or word, the present invention eliminates this one-to-one type of arrangement and instead intersperses “false” symbols into the message. These “red herrings” within the message make an intercepted message practically impossible to decipher. As example, assume the intercepted message has one hundred characters. To even start deciphering the message, the actual number of “red herrings” and their locations within the message must be known before attempting to break the code; otherwise, if a single red herring is left in the message to be deciphered, this missed red herring will make the deciphered message garbage, even if the encryption methodology is already known!

This system uses a computer which creates a message having both true encrypted characters with false (Red Herring) characters intermixed therewith. For purposes of discussion only, the encryption used in the creation of these messages is that as outlined above; those of ordinary skill in the art recognize that a variety of encryption techniques are useable in this context.

To enhance the affect of the red herring, the character used as the red herring is changed each time it is used. In this way, the red herrings are not easily identified.

In one embodiment, a template is created which is to be communicated to a remote computer. As example, the template is an array which serves as the final encrypted message.

In operation of this embodiment, the message to be encrypted is received either from an operator or as a file. The placement of the false information (acting as Red Herrings) is established and placed within the template at locations which are scattered throughout the template. In the preferred embodiment of this embodiment, the locations for the red herrings are established using a sequence generator as outlined above.

This sequence generator preferably uses the same initiation key as is used to encrypt the true message, in other embodiments, a second initiation key is used for the red herring sequence generator.

In an enhanced application, several sequence generators are used to scatter red herrings throughout the message to make the deciphering of a captured message even more difficult to “break”.

The true encrypted characters are then interwoven within the template without disturbing the false characters. The true encrypted characters are ideally created using the above described encryption methodology; that is, a sequence generator is chosen and an initiation key is obtained from the operator.

In some embodiments, a destination address used for the communication of the completed message, is used to select the sequence generators; thereby making the message uniquely encrypted (both with true encrypted characters and red herring characters) for the recipient.

Once the template is completed, the template, complete with red herring characters and true characters, is sent to the proper recipient, who, knowing how the red herrings are placed (using the proper sequence generator and initiation key), simply removes the red herrings from the template and then decrypts the message.

In another embodiment of the template, the true encrypted message is placed within the template and then the red herrings are “pressed” into the array; thereby “forcing” the red herrings into the template without modifying the true encrypted values within the template, only moving the true encrypted values to accommodate the placement of the red herrings within the template.

In another embodiment, the location of the false information, the false information, and the true information are all established “on the fly” one character at a time and are selectively communicated to the remote computer. This embodiment eliminates the use of a template and permits messages to be encrypted and sent as the message is entered into the computer; and on the receiving end, to have the incoming message decrypted as the message is being received.

In yet another embodiment, a set of character values are chosen to create a red herring set. This set of character values is a subset of the potential characters. As example, if the potential character set is all of the ASCII characters, the red herring set could be the values of: 32, 97, 114, 126, and 200). Obviously, the only limit on the selection of the red herring set is the imagination of the programmer.

In this embodiment, using a red herring set, each time the encryption methodology operating on the original message generates any value within this red herring set, a red herring is placed within the message and another value is generated to serve as the true encrypted value.

As noted earlier, while the present discussion related to the above encryption technique, the invention is not so limited and any encryption methodology is available for these embodiments. Those of ordinary skill in the art readily recognize these encryption techniques.

The invention, together with various embodiments thereof, will be more fully explained by the accompanying drawings and the following descriptions thereof.

### DRAWINGS IN BRIEF

FIG. 1 is a block diagram of the preferred embodiment of the mail server system.

FIG. 2 is a block diagram of the audio/video/program download system of the present invention.

FIG. 3 is a block diagram illustrating secure communications between multiple users.

FIG. 4 is a block diagram of an embodiment of the invention used to provide security for a data base.

FIG. 5 is a block diagram showing the use of differing encryption systems between a sender and a receiver.

FIG. 6 is a block diagram of the preferred embodiment for the creation of secure usage of a software program.

FIG. 7 is a flow-chart illustrating an embodiment of the remainder subroutine used in the preferred encryption technique.

FIG. 8 is a flow-chart illustrating the preferred embodiment for the encryption technique.

FIG. 9 is a flow-chart illustrating the preferred embodiment of the decryption technique.

FIGS. 10A and 10B are flow-charts illustrating an embodiment of the audio/video/program download and play-back respectively.

FIGS. 11A and 11B are flow-charts of the preferred embodiment's operation for mail for when a message is to be sent and when a message is received.

FIG. 12 is a table illustrating the preferred embodiment's process.

FIGS. 13A and 13B are encryption and decryption flowcharts of an embodiment of the red herring embodiments.

FIG. 14 is a frontal view of a screen showing the application of keys for the sequencers.

FIGS. 15A and 15B are flowcharts of an alternative embodiment of the red herring embodiments for encryption and decryption respectively.

FIG. 16A illustrates the steps used in one embodiment of the invention in which a template is created using red herrings.

FIG. 16B illustrates the steps used to decrypt the template created in FIG. 16A.

FIGS. 17A and 17B are flowcharts illustrating an embodiment of the invention used to change the parameters used between a transmitting party and a receiving party so that the sequence generators vary from one transmission to the next.

### DRAWINGS IN DETAIL

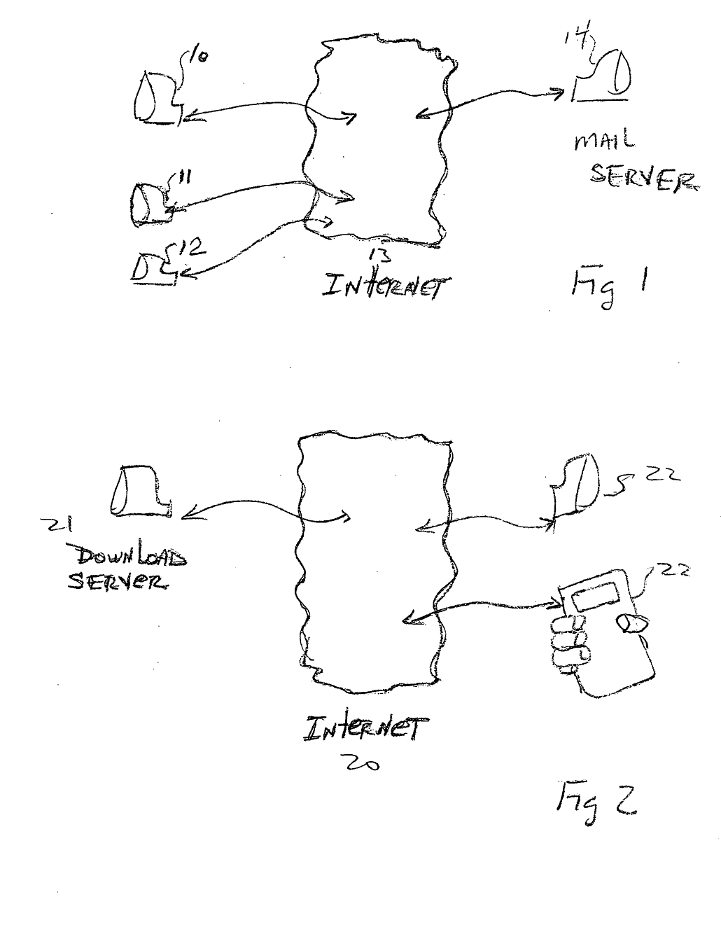

FIG. 1 is a block diagram of the preferred embodiment of the mail server system embodiment of the invention.

Mail server computer 14 is accessible to multiple computers via the Internet 13. For this illustration, three computers are used. Computers 10, 11, and 12, are connected to the Internet and by extension, also to mail server 14.

Two different types of operations are possible with this configuration:
(1) one computer wants to communicate with another in a secure manner, but, the two have not done so previously; and,
(2) two computers wish to securely communicate with each other and have done so previously.

Addressing the first scenario, computer 10 is equipped with the encryption software (M) and a set of keys as defined above (in an alternative embodiment, computer 10 is configured to establish the key using one of the techniques above); but, computer 11 does not have the decryption software (M′) nor any keys.

The user of computer 10 enters a communication, MSG and a destination address (i.e. the e-mail address for computer 11 (or some other identifier). Computer 14 determines that this destination has not been used before so one of the keys from the set of keys is arbitrarily selected. Using this key and the mapping function, M. The communication MSG is encrypted.

The now-encrypted communication, an identifier of the key used, and the destination address, are communicated to the mail server computer 14 by computer 10 via Internet 13.

Mail server computer 14 recognizes that computer 10 has not previously communicated securely with computer 11. Using the destination information, computer 14 sends an unencrypted message to computer 11 and provides computer 11 with the capability to download the decryption function/software M′ together with a single key which is to be used to decrypt the encrypted communication.

In this manner, computer 11 is provided with the capability to receive secure communications from computer 10; but, computer 11 is not able to send secure communications back to computer 10 (nor to any other computers) without acquiring the encryption mapping capability M together with the entire set of keys.

In the second scenario, the case where two computers have already established a relationship, computer 10 is equipped with the encryption software (M) and computer 12 has the decryption software (M′) together with a set of keys.

The user of computer 10 enters a communication, MSG and a destination address (i.e. the e-mail address for computer 12 or other identifier). Using the destination address (an identification of computer 12), computer 10 identifies a specific key within the set of keys and uses the specific key with the mapping function M on the communication MSG to create the encrypted message.

The encrypted message is communicated from computer 10 via the Internet 13 to mail server computer 14. Mail server computer 14, knowing the source of the now-encrypted communication, as well as the destination address (computer 12), determines that these two computers have been in previous secure communications; hence, mail server computer 14 passes the communication along to computer 12.

In an alternative embodiment, mail server computer 14 decrypts the message from computer 10 and re-encrypts the message specifically for computer 12. This embodiment provides another level of security.

In yet another embodiment, mail server computer 14 either directly or instructs computer to modify its memory so that the next time a secure communication is sent from computer 10 to computer 12, a different key is used. This modification provides additional security relative to the communications.

Upon receipt of the encrypted message, computer 12, using the source identifier of computer 10, identifies the proper key from its memory which is to be used in the decryption process. This identified key, together with the decryption mapping function M′, allows computer to recreate the original message and display (or place in memory) the original message for the user of computer 12.

Computer 12 is also able to send a secure communication to computer 10 in a manner as outlined above for a communication between computer 10 and computer 12.

Note, ideally, the entire encryption/decryption process is “transparent” to the users of computer 11 and computer 12. That is, the users only “see” decrypted material and all encryption and decryption is done automatically.

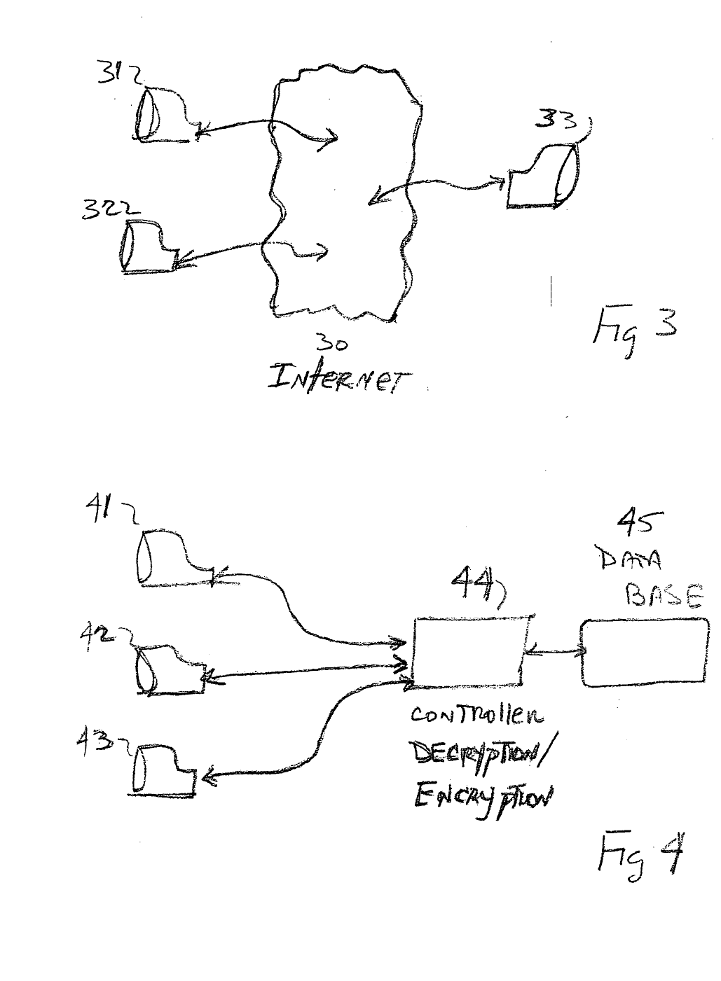

FIG. 2 is a block diagram of the audio/video/program download system of the present invention.

In this situation, the security which is sought isn't against a third party interloper, but, instead is from the user of computer 22 who, while authorized to obtain the data, may want to download data and then improperly share the downloaded data with others who have not paid or who are not authorized to have the downloaded data.

Download server 21 interacts with remote computers via Internet 20. Download server 21 contains digital data which is used to create music, audio, and/or video representations.

When computer 22 wants to acquire such data, contact is made by computer 22 which requests a specific set of data from download server 21. During the request, computer 22 communicates a key specific to computer 22 which is to be used for the encryption and decryption of the data set. This key is ideally an internally stored value or sequence.

Using the key for computer 22 and the data, download server 21 encrypts the data and communicates the encrypted data via Internet 20 to computer 22 which stores the encrypted data in memory. While in some embodiments, the data is decrypted prior to storage, in the preferred embodiment of this system, the encrypted data set is stored in memory and is not decrypted until ready for use.

During use of the encrypted data set by computer 22, portions of the encrypted data set are withdrawn from the memory and are decrypted. This decryption step is accomplished using the internally established key within computer 22; thereby making decryption by any other machine impossible since decryption requires the unique key uniquely found within computer 22.

To further enhance the security of the downloaded material, ideally, only a portion of the encrypted data set is ever withdrawn and decrypted; without the data ever being fully decrypted, the data is not valuable or usable by any other device except computer 22.

In like fashion, handheld computer 22 is able to interact with download server 21 via Internet 20 and obtain data which, when used by handheld computer 22 produces music, audio information, or movies.

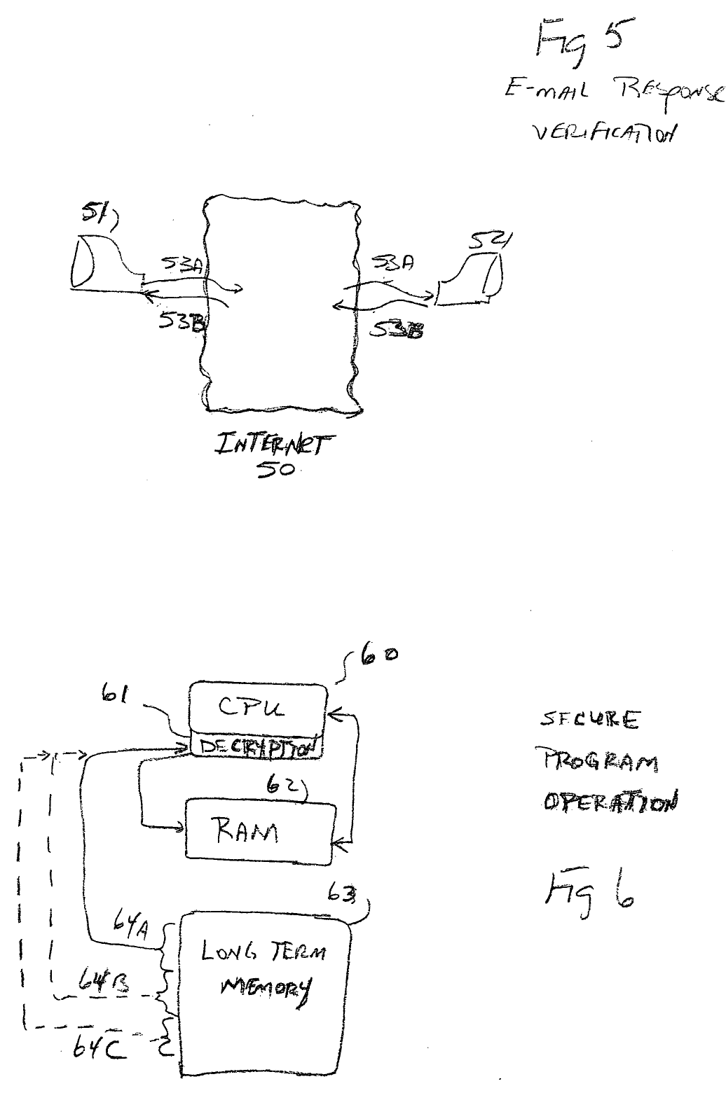

FIG. 3 is a block diagram illustrating the secure communications between multiple users.

In this embodiment, a mail server is not employed, rather, traditional e-mail communications systems are used for the delivery of the messages. Each computer (31, 32, and 33) is able to send messages which have a destination as well as a message (with or without attachments).

In this embodiment, when a user of computer 31 wants to send a secure transmission to a remote computer 33. Computer 31, by knowing the destination, is able to use the appropriate key to encrypt the message and any attachments for computer 33. On receiving the message, since computer 33 knows the source of the message, computer 33 knows the proper key to use in decrypting the message.

When the user of computer 31 wants to send a secure message to computer 32, a different key is chosen. Computer 31 is creating a series of communications with any number of remote computers, but, each remote computer receives the message in its own unique “language” which is not discernable by the other remote computers. In this manner, unique communications are available. Note, in some situations, a particular key is used with many different computers; but, the selection of the key is still based on the destination computer.

Should computer 33 receives a message purportedly from computer 31, when the message is decrypted, if the resulting message is gibberish, then computer 33 knows that the message did not originate from computer 31 (since the “language” did not match); conversely, if the message makes sense, then the user of computer 33 is assured of the true source of the message.

This technique prevents hackers from assuming a false identity merely to gain access to a computer.

To further enhance this security shield, in one embodiment, a portion of the message being communicated contains an encrypted key which is to be used for the next transmission or reply. This makes it even more difficult for the hacker to counterfeit his identity from the receiving computer. As example, the tenth characters is used as a source in the generation of random numbers by a canned random number generator.

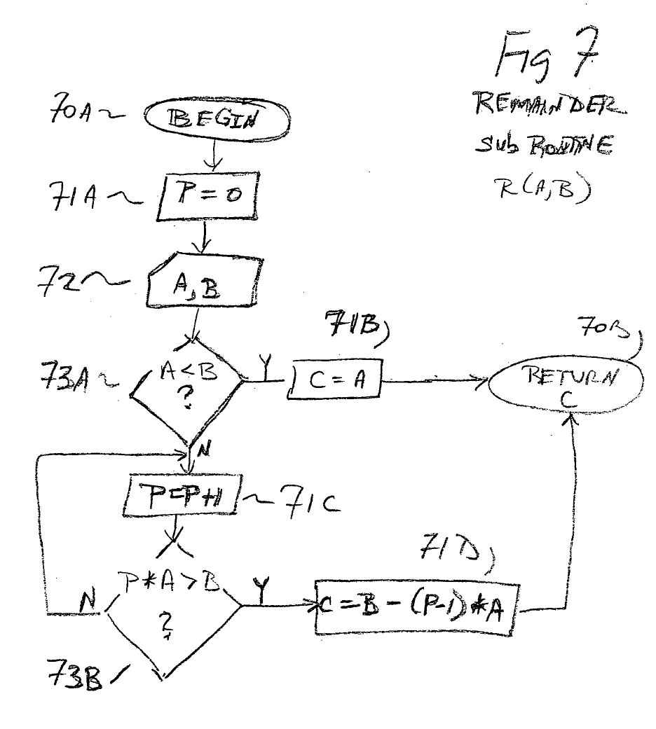

FIG. 4 is a block diagram of an embodiment of the invention used to provide security for a data base. This embodiment of the invention provides security for a data base which is accessed by many remote sites. Data-base access operations are commonly found in such businesses as: credit card companies; state motor vehicle departments; internal revenue; banking facilities; and many more obvious to those of ordinary skill in the art.

This embodiment prevents an authorized user of the data base from improperly collecting data from the data base for nefarious uses.

In this embodiment, data base 45 contains a large amount of proprietary information which is accessible by remote computers 41, 42, and 43. The material within data base 45 is encrypted and remains encrypted using any of the techniques already discussed or others obvious to those of ordinary skill in the art.

When the operator of computer 41 seeks a certain data set, such as that for a particular customer, the inquiry is sent to controller decryption/encryption 44 which identifies the particular data set within data base 45 (which is encrypted) and requests that encrypted information to be sent by data-base 45 to controller/decryption/encryption 44.

Controller decryption/encryption 44, in the preferred embodiment, decrypts the data set from its stored encrypted state and then re-encrypts the data set using a key which is specific to computer 41. When the secondly encrypted data set is received by computer 41, computer 41 decrypts the data set for use by the user of computer 41.

The user of computer 41 is able to manipulate the data set as per their job (such as changing certain elements to reflect such things as an increased loan amount). To store the up-dated data set, computer 41 encrypts the up-dated data set and communicates the encrypted material back to controller 44.

Controller 44, upon receiving the encrypted data set, recognizes the source of the material and, using the key appropriate for computer 41, decrypts the data set and then re-encrypts the data set commensurate with the encryption technique and key used for data storage within data base 45.

In this manner, the user of computer 41 is only able to acquire a limited amount of data, as the contents of the data base are kept encrypted using a key which is unknown to the user of computer 41.

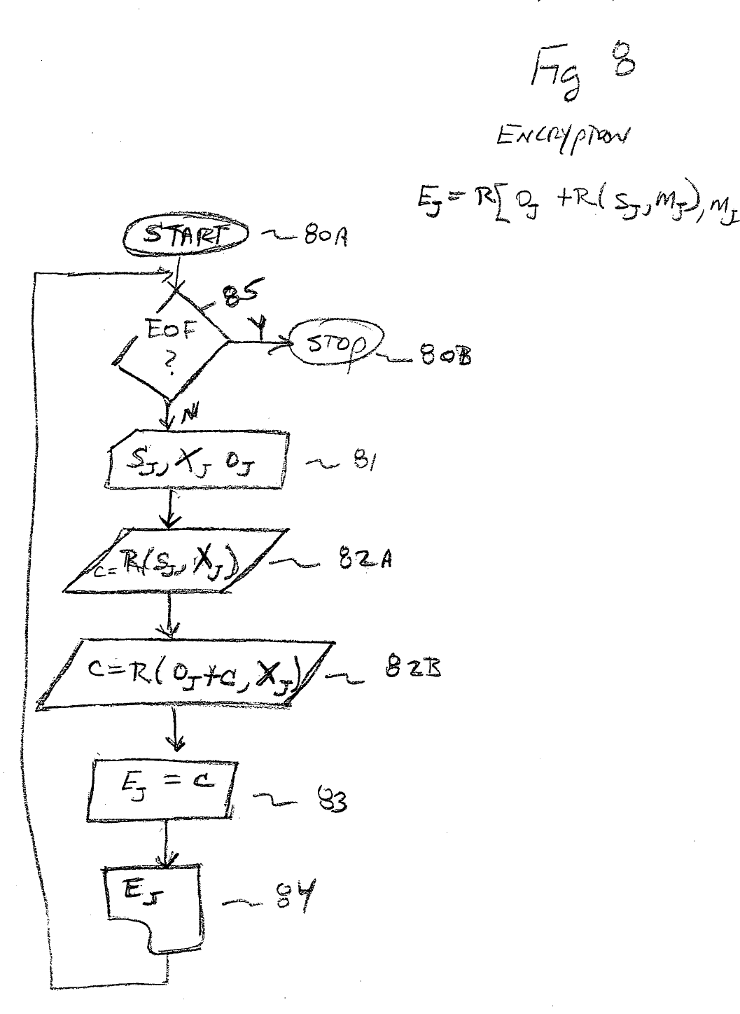

FIG. 5 is a block diagram showing the use of differing encryption systems between a sender and a receiver.

As noted earlier, communication between two computers requires that each of the computers is able to identify the source of the information and the address where information is to be sent. This is true whether the transmission is considered an e-mail or an instant message.

As such, computer 51 and computer 52, when communicating with each other via Internet 50, identify themselves and each other with each of the messages being sent. While some embodiments of the invention utilize the same key for the encryption for the outgoing messages (which is also used for the decryption process), in the preferred embodiment each of the computers 51 and 52 use a unique key for the reply message. This causes message 53A to be encrypted differently than message 53B, even though the same two computers are being used for both messages.

This structure keeps someone from being able to re-create the entire “conversation” between computers 51 and 52 without knowing both encryption keys.

This technique is also extremely useful for identifying if the source of the message is who they claim to be, as a hacker will be unable to properly encrypt a message; hence, when the improperly encrypted message is decrypted, “garbage” is created.

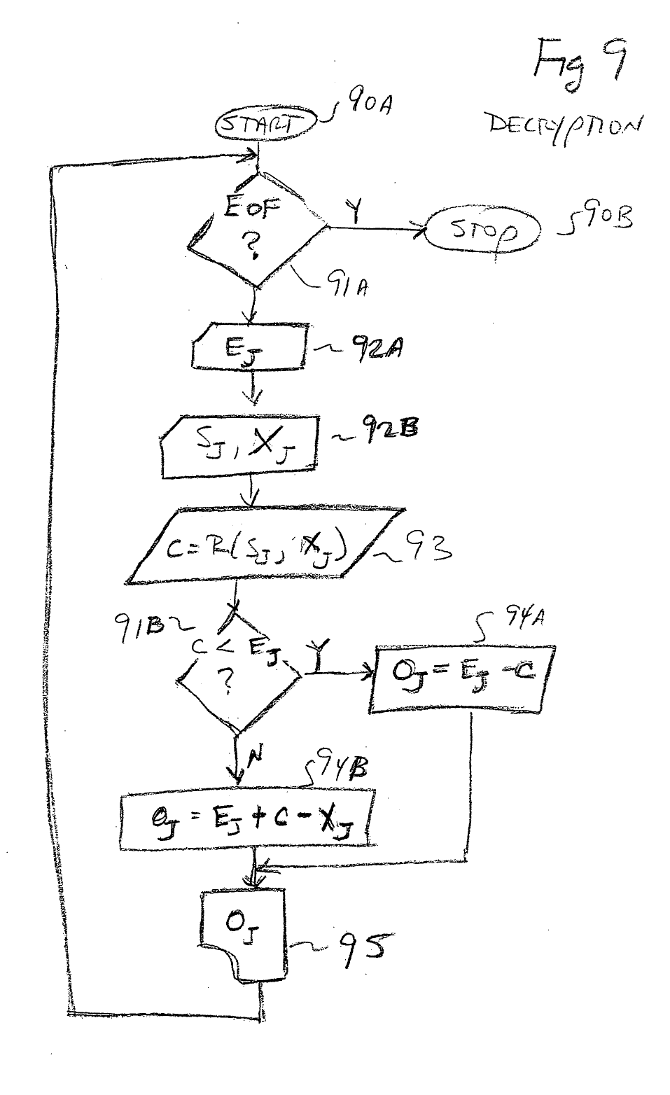

FIG. 6 is a block diagram of the preferred embodiment for the creation of secure usage of a software program to prevent the pirating of software.

For explanation of this figure, a software program (such as a spread sheet program) has been stored in the long term memory 63 of the computer. The program within long term memory 63 is encrypted using an identifier (such as the serial number) of the computer as the key for the encryption.

When the program is to be operated, Central Processing Unit (CPU) 60 directs a portion of the program 64A to be withdrawn and decrypted 61. The decrypted portion is communicated to the volatile or working memory (e.g. Random Access Memory—RAM, or the like) 62 which is used by CPU 60 in performing the program segment.

When further portions of the program within long term memory 63 are needed, these sections are selectively pulled 64B and 64C, decrypted 61, and used to refresh or replace the contents of RAM 62.

At no time is the entirety of the program within long term memory 63 fully decrypted; rather, only portions of the program are accessible in a decrypted form and hence only a portion of the program is ever available to be “pirated”.

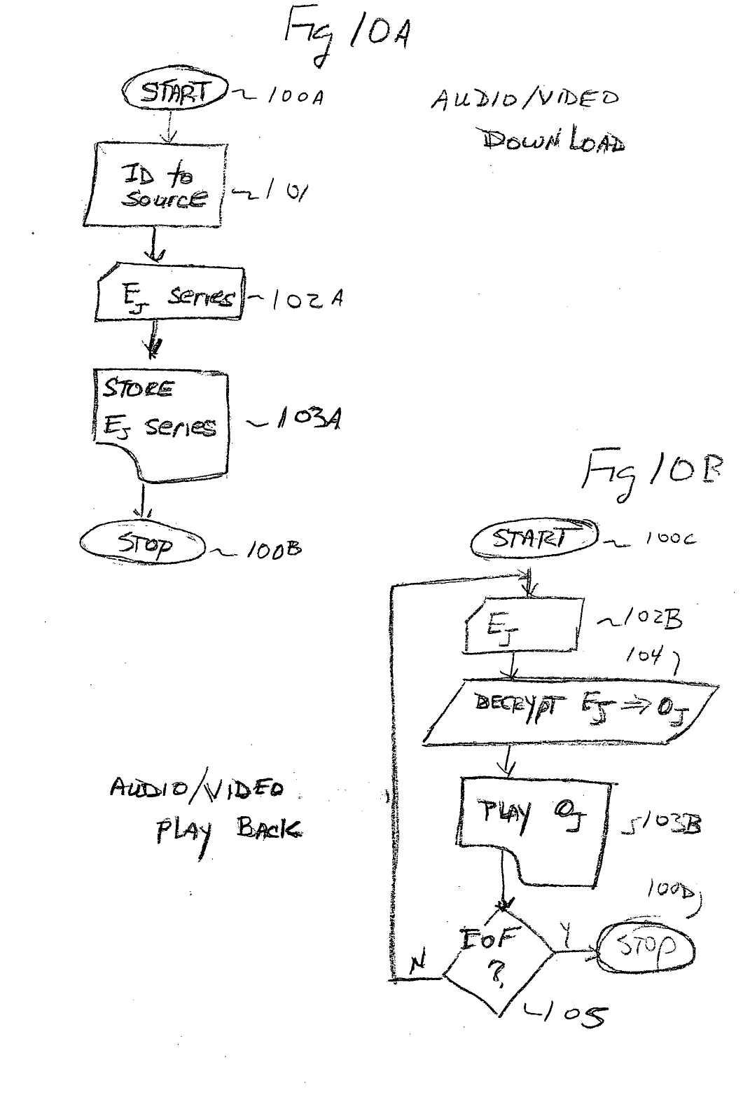

FIG. 7 is a flow-chart illustrating an embodiment of the remainder subroutine used in the preferred encryption technique.

This encryption technique uses a remainder operation in the mapping operations, whether that operation is for encryption or decryption. In this embodiment, the remainder subroutine (R(A,B)) receives the values A and B and returns C, the whole number remainder when A is divided by B.

After the subroutine begins 70A, a pointer is set to zero 71A and the values A and B are obtained 72. A decision is then made if A<B 73A and if so, C is assigned the value A 71B and the subroutine returns C 70B.

If the check of A<B 73A is no, then the pointer is incremented 71C and a determination is made on if the product of P*A>B is made 73B. If the determination is no, then the pointer is incremented again 71C and the process continues until P*A>B (Yes 73B); C is assigned the value of B−(P−1)*A 71D and the program returns the value C 70B.

In this manner, the remainder value is established.

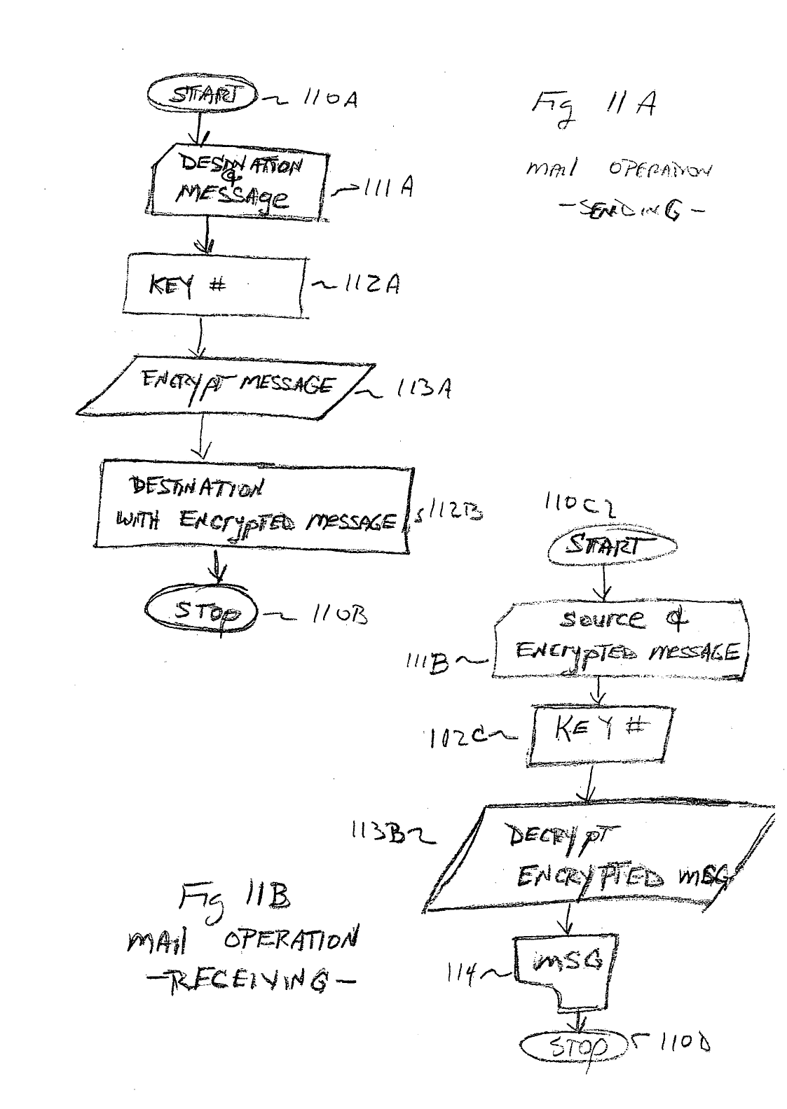

FIG. 8 is a flow-chart illustrating the preferred embodiment for the encryption technique. The mapping function for this encryption is (using the references of above):
Eⱼ=R[Oⱼ+R(Sⱼ,Xⱼ),Xⱼ] J=1,N

Once the program starts 80A, a determination is made to see if the End of File (EOF) 85 has occurred. An EOF indicates that the entire message has been read. If there has been an EOF, then the program stops 80B; otherwise, the adjustment value from the key (Sⱼ), the maximum number of potential characters (Xⱼ) and the original symbol (Oⱼ) are obtained 81.

The remainder is obtained (R[Sⱼ, Xⱼ]) 82A and the value C is returned. The remainder is obtained for (R[Oⱼ+C, Xⱼ]) 82B and C is returned. The encrypted value Eⱼ is assigned the value C and the Eⱼ is then displayed, communicated, or stored 84. The program then returns to check for the EOF 85.

In this manner, the entire message is encrypted, symbol by symbol using a key for the mapping/encryption process.

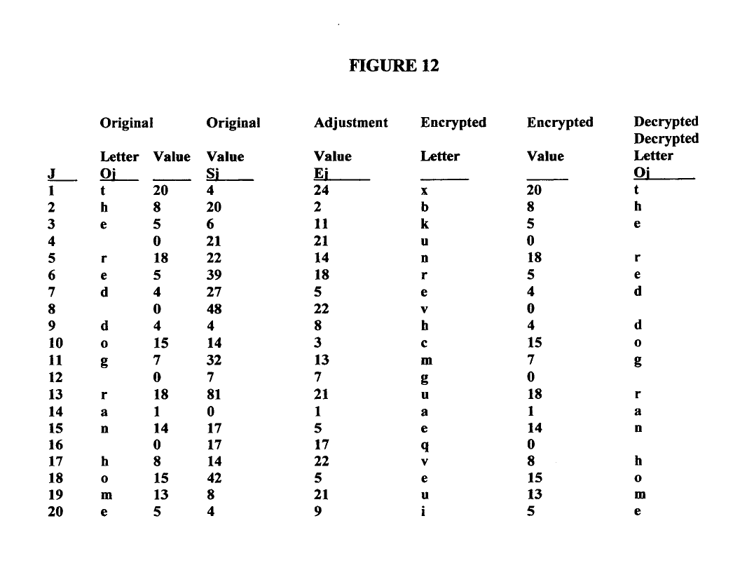

FIG. 9 is a flow-chart illustrating the preferred embodiment of the decryption technique.

As noted earlier, ideally the decryption process is performed automatically without any human initiation. In the preferred embodiment of the encryption, the program outlined in FIG. 9 is initiated automatically upon the receipt or opening of an e-mail, instant message, or any other type of message.

Once the program starts 90A, a determination is made on if an End Of File (EOF) has occurred 91A. An EOF indicates that the entire message has been decrypted; hence, on EOF, the program stops 90B.

If there hasn't been an EOF, then the encrypted letter Eⱼ is obtained 92A followed by the adjustment value Sⱼ and the maximum level Xⱼ 92B. The remainder subroutine is initiated on Sⱼ and Xⱼ 93 returning the value C.

A comparison is then made to determine if C is less than the encrypted letter Eⱼ 91B. If C<Eⱼ, then the original letter Oⱼ is Eⱼ−C 94A; otherwise, the original letter Oⱼ is Eⱼ+C−Xⱼ 94B.

With the determination of the original letter Oⱼ, the original letter Oⱼ is displayed (or stored) 95 and the program returns to see if an EOF has now occurred 91A.

In this manner, the entire encrypted message is decrypted letter by letter using the adjustment values as the key and the maximum value to assist in the mapping procedure.

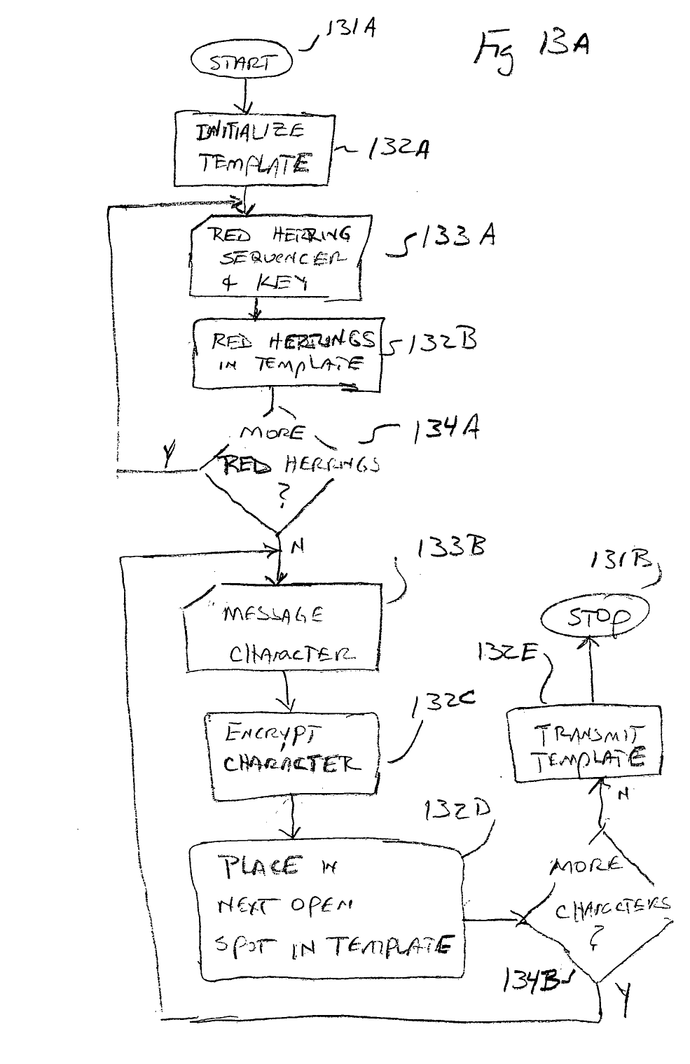

FIGS. 10A and 10B are flow-charts illustrating an embodiment of the audio/video/program download and play-back respectively.

Referencing FIG. 10A, the download component, once the program starts 100A, the computer's identification (i.e. the serial number) is transmitted to the source 101 (where the data is being downloaded from). The source then transmits the encrypted series Eⱼ 102A which is then stored within the computer's memory 103A. The program then stops 100B.

When the encrypted series Eⱼ is to be played (FIG. 10B), the program starts 100C and an particular value Eⱼ is pulled from memory 102B and this value is decrypted resulting in the decrypted value, the original character/value Oⱼ 104. The original character/value Oⱼ is played 103B.

An EOF check 105 is made. If the EOF has been encountered, then the program stops 100D; otherwise the program loops back and pulls another encrypted value 102B.

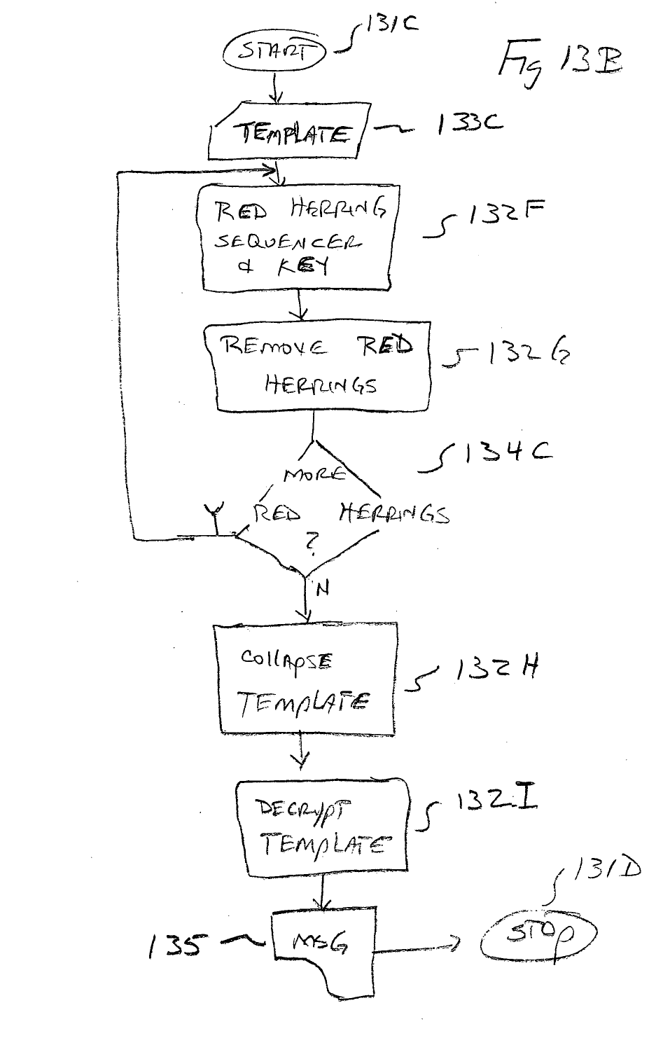

FIGS. 11A and 11B are flow-charts of the preferred embodiment's operation for mail for when a message is to be sent and when a message is received.

A computer, when sending a message (FIG. 11A) starts the program 110A and obtains the destination and message 111A. Using the destination, a key value is determined 112A and the message is encrypted 113A. The encrypted message is then transmitted through normal channels or via a mail server to the destination 112B and the program stops 110B.

An incoming encrypted message is preferably handled as shown in FIG. 11B. The program starts 110C and the source of the message and the encrypted message is obtained 111B. Using the source information, the associated key for decryption is identified 112C and the encrypted message is decrypted 113B. The now-decrypted message is displayed for the user 114 and the program stops 110D.

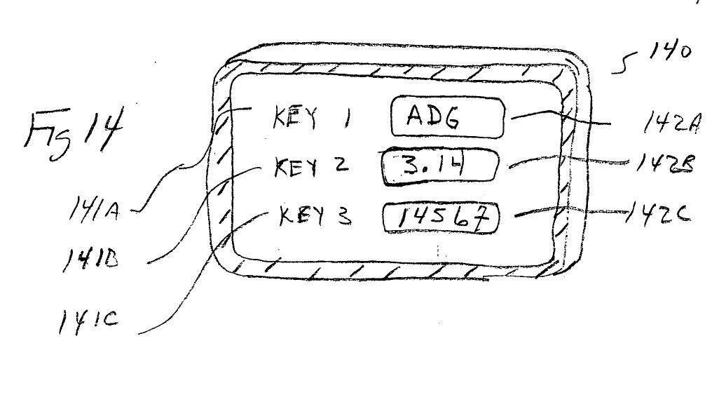

FIG. 12 is a table illustrating the preferred encryption and decryption process.

Using the preferred mapping function (Eⱼ=M (Oⱼ, Sⱼ)=R[Oⱼ+R(Sⱼ, Xⱼ), Xⱼ]), FIG. 12 illustrates how the message: “the red dog ran home” 120 is first encrypted and then decrypted.

For this example, the numerical values range from 0=blank space, 1=“a”, 2=“b” . . . 25=“y”, and Xⱼ is a constant value 26.

In this example, the key Sⱼ, 121 which is used is defined by the series:
4 20 6 21 22 39 27 48 4 14 32 7 81 0 17 17 14 42 8 4

As illustrated, the receiving computer (doing the decryption) uses a reversing algorithm together with the key set Sⱼ, which were also used in the encryption operation.

The power of this particular encryption technique is clear when the original message is compared to the encrypted message which is communicated over the distributed network of computers.
Original Message: the red dog ran home 121
Transmitted Message: xbkunrevhcmguaeqveui 122
   thereby providing encryption which is unique between the two parties and making the transmission difficult if not impossible to decrypt.

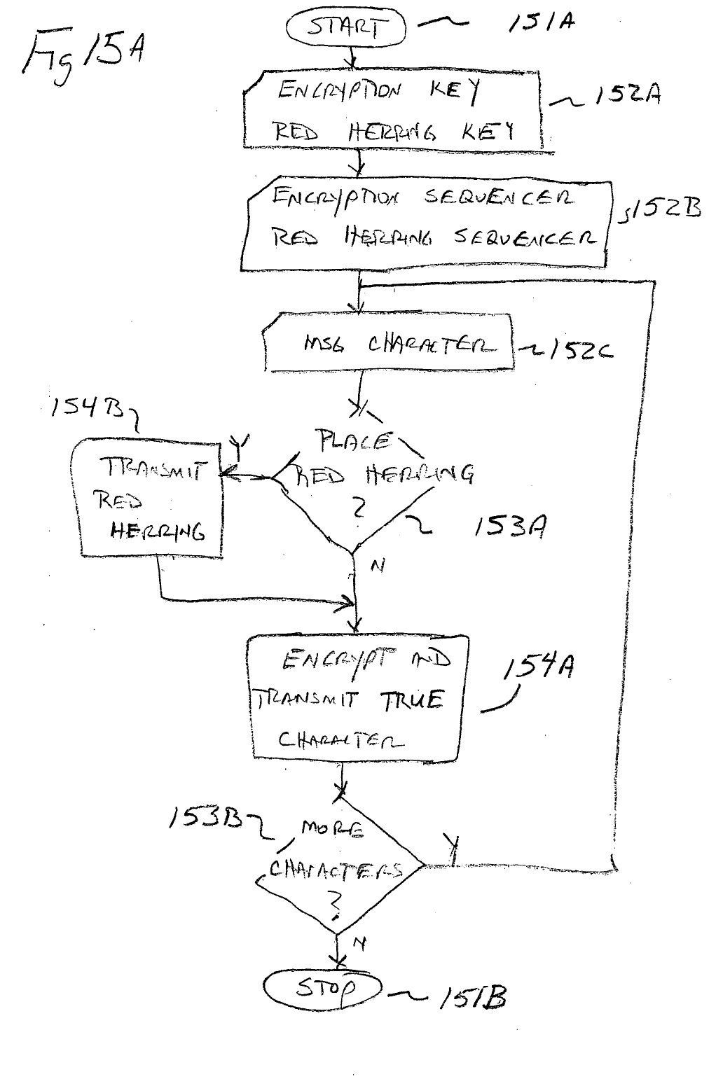

FIGS. 13A and 13B are encryption and decryption flowcharts of an embodiment of the red herring embodiments.

Referring to FIG. 13A, a flow chart of an embodiment of the invention for the encryption using red herrings and a template, once the program starts 131A the template is initialized 132A. Initialization of the template in this embodiment is accomplished by creating a “blank” template. A “blank” template in this context is one which has a predefined character therein. Ideally this is a character which is not within the red herring set; in this way, locations within the template which have had red herrings/false information placed therein are easily identified during the encryption phase.

The red herring sequencer and key is obtained 133A. These sequence generators were described earlier and include such diverse sequence generators as:

| | | |
|---|---|---|
| Sⱼ = 3*Sⱼ₋₁ + 2*Sⱼ₋₂ + Sⱼ₋₃ | OR | Sⱼ = 3*Oⱼ₋₁ + 2*Oⱼ₋₂ + Oⱼ₋₃ |
| Sⱼ = Abs(3*Sⱼ₋₁ − (Sⱼ₋₂ + Sⱼ₋₃)²) | | Sⱼ = Abs(3*Oⱼ₋₁ − (Oⱼ₋₂ + Oⱼ₋₃)²) |
| Sⱼ = Sⱼ₋₁ + Sⱼ₋₂ + Sⱼ₋₃ | | Sⱼ = Oⱼ₋₁ + Oⱼ₋₂ + Oⱼ₋₃ |
| Sⱼ = Sⱼ₋₁ + 2 | | Sⱼ = Oⱼ₋₁ + 2 |
| Sⱼ = 2*Sⱼ₋₂ + 5 | | Sⱼ = 2*Oⱼ₋₂ + 5 |

Those of ordinary skill in the art readily recognize that a variety of sequence generators are available for this task.

Using the sequence generated, the values are “normalized” to fit the desired step range desired by the user or program. This step range defines the maximum number of true characters which may be placed between the red herrings.

Using the key and the sequencer, the red herrings are thus placed within the template 132B and a check is made to see if more red herrings need to be generated 134A. This process cycles until all of the red herrings have been placed into the template.

The actual red herring character placed within the template varies according to the sequence generator and is established as outlined above. In this way, even the red herrings are encrypted, thereby making it even more difficult to crack the encryption methodology.

In some alternative embodiments of this invention, this step of placing red herrings scattered within the template is repeated for multiple sequence generators. This places “layers” of red herrings within the template. In order to “crack” or break this code requires the additional knowledge of the number of times red herrings have been scattered throughout the template.

To accomplish this task, placing multiple red herring layers within the template, the cycle of steps 133A through 134A are repeated for different sequence generators.

A character is taken from the message 133B and is encrypted 132C. This “true character”, (the encrypted character from the true message) is then placed in the next available opening of the template 132D (i.e. the next location not occupied by a red herring).

A check is made to see if there are more characters from the message to encrypt 134B and if there is, the process cycles until all of the characters from the message are encrypted and placed within the template.

When the template is completed, the template is communicated to a remote computer 132E and the program stops 131B.

In the preferred embodiment of the template use, the sequence generators used to place the red herrings, create the character used for the red herrings, and encrypt the message are chosen based upon the final destination of the template, that is, the address of the remote computer. In this manner, the entire process is unique to the receiving computer, making the message even more difficult crack by an interloper.

FIG. 13B is a flow chart of an embodiment of the invention for decrypting a template having red herrings.

Once the process of decrypting the message generated by the process outlined in FIG. 13A is started 131C, the template is received 133C and the sequence generator for the red herring 13 and the key is established 132F. In the preferred embodiment, the sequence generator and the key for the red herrings is based upon the source of the message.

Using the sequence generator and key, the red herrings are removed 132G until all of the red herrings within the template have been eliminated 134C.

In this embodiment, the template is then “collapsed” 132H, that is, the “holes” left from removing the red herrings are removed from the revised template. This revised template 19 represents only “true characters”, those that are representative of the original message, even though the template is encrypted.

The template is then decrypted 132I and the message, in a decrypted form, is displayed 135. The program then stops 131D.

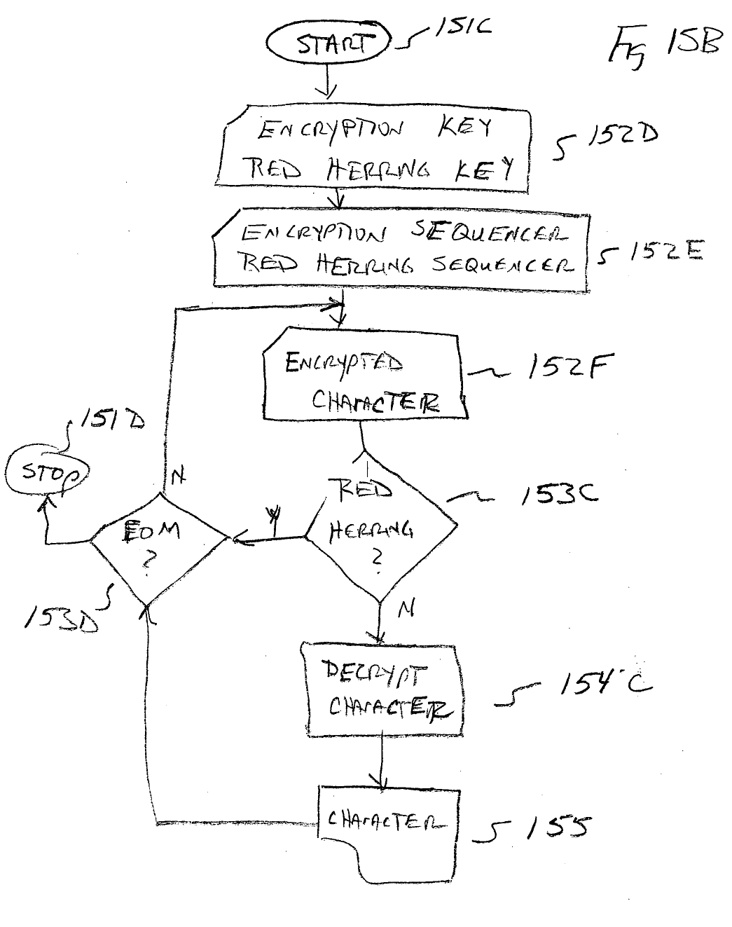

FIG. 14 is a frontal view of a screen showing the application of keys for the various sequence generators used as outlined above.

Screen 140 communicates that three different keys 141A, 141B, and 141C are required for the process. These keys form a “combination” which the user has previously created. As illustrated, the keys can be any type of character 142A, 142B, and 142C.

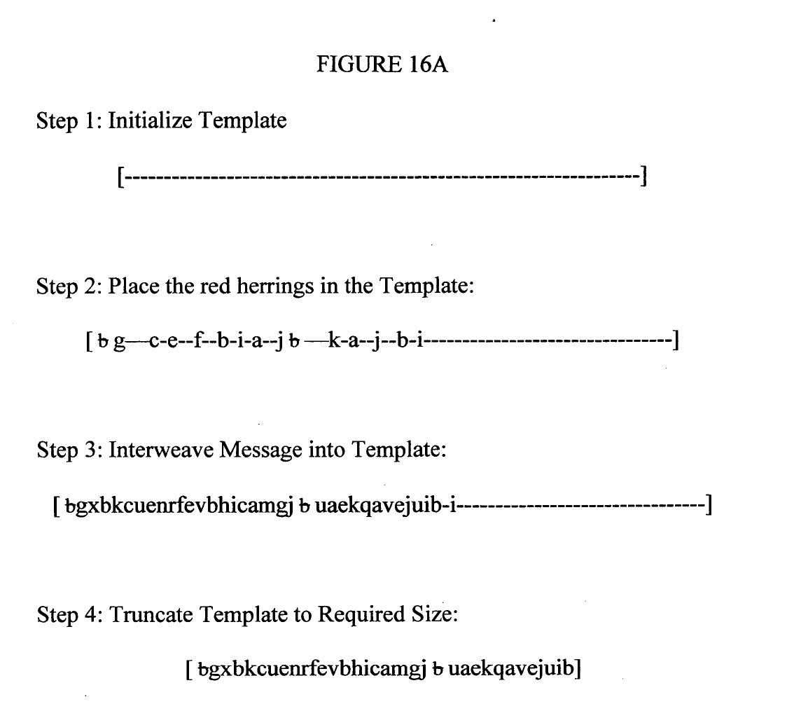

FIGS. 15A and 15B are flowcharts of an alternative embodiment of the red herring embodiments for encryption and decryption respectively.

Referring to FIG. 15A, a flowchart which illustrates an embodiment of the invention which encrypts and transmits characters “on the fly”, once the program starts 151A the encryption key and the red herring key are obtained 152A, either from the user or from memory. The encryption sequence generator and the red herring sequence generator are also established 152B.

The message character is then received 152C and the location is checked to see if it corresponds to where a red herring should be placed 153A; if it is, then a red herring is transmitted 154B. The true character is encrypted and transmitted 154A.

A check is made to see if there are more characters to encrypt 153B and if so, then the program cycles to repeat the process; otherwise, the program stops 151B.

Referring to FIG. 15B, a flowchart which illustrates the decryption embodiment working with the encryption methodology illustrated in FIG. 15A, after the program is started 151C, the encryption key and red herring key is obtained 152D either from the user or from memory. The sequence generators for the encryption and the red herrings is obtained 152E. As noted earlier, in the preferred embodiment, the sequence generators are established using the source of the message to identify them.

A check is then made to see if the character corresponds to a red herring location 153C. If the location is not a red herring (as defined by the red herring key and red herring sequence generator) then the character received is a “true character” and it is decrypted 154C and displayed 155.

A check is made on if that character was the End of Message (EOM) 153D, if it was, then the program stops 151D; otherwise, the next encrypted character is obtained 152F and the cycle continues until the entire message is decrypted.

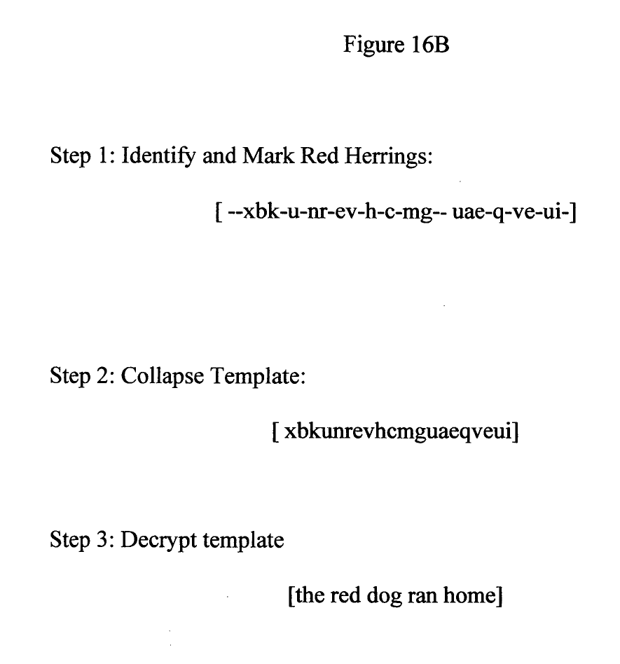

FIG. 16A illustrates the steps used in one embodiment of the invention in which a template is created using red herrings.

Step 1 is the initialization of the template. In this illustration brackets are used to denote the start and finish of the template and the dash is used to denote a location within the template (an array in this illustration) that has not been assigned a value.

Step 2 requires the insertion of the red herrings or false information. In this context, “red herrings” and “false information” are used to denote characters which are added to the encrypted message to confuse or misdirect the interloper wanting to decrypt the message.

As way of example, the spacing between the red herrings is generated by the following sequence generator with associated key.
Sⱼ=ABS(Sⱼ₋₃+Sⱼ₋₂−Sⱼ₋₁)
Key=2 3 5

This sequence generator, with associated key, provides the following sequence of values:
0 8 3 5 6 2 9 1 10 0 11 1 10 2 9 . . .

In this illustration, the spacing between red herrings is a maximum of four spaces; hence, the above sequence maps into a space of 4 as (computed using the remainder algorithm illustrated above):
0 0 3 1 2 2 1 1 2 0 3 1 2 2 1 . . .

In this illustration, the same sequence generator is used to create the red herring symbols. Using the same alphabet as used in FIG. 12, the sequence generator for the red herrings produces the following encrypted red herring characters (note, “b” is used to denote a blank for this illustration):
b g c e f b I a j b k a j b I

Knowing the spacing between the red herrings and the red herring characters, the red herrings are placed within the template.

In some embodiments of this invention, a single sequence of red herrings is placed within the template (as in this illustration); in other embodiments, differing sequence generators with initializing keys are used in a repetitive fashion to create different “layers” of red herrings within the template before the “true characters” or actual encrypted message is interwoven into the template.

In an alternative embodiment, steps 1 and 2 are replaced with a selection of a template which already has the red herrings included therein. This prepared template with the red herrings is chosen from a library of such templates. Ideally, to frustrate an interloper, the prepared template used between two individuals is changed for each transmission.

In this illustration, the next step is to encrypt the message and to interweave the encrypted characters into the template (Step 3).

For the actual encryption, the message and encryption shown in FIG. 12 is used. This encrypted message is:
xbkunrevhcmguaeqveui

At this point, the true encrypted characters and the false encrypted characters are interwoven into the template and the template is truncated to the size needed (step 4) by eliminating any characters from the first initialization character onward. It is this truncated template which is communicated to the remote computer.

FIG. 16B illustrates the steps used to decrypt the template created in FIG. 16A.

Upon receiving the template, the first step in decrypting the message is to identify the red herrings using the same sequence generator and key as was used to place them. Each of the red herrings are now changed to an “ignore” character.

Step 2 is the removal of the “ignore” characters to form a template for proper decryption (now shown in step 3).

The third and final step decrypts the template to form the original message.

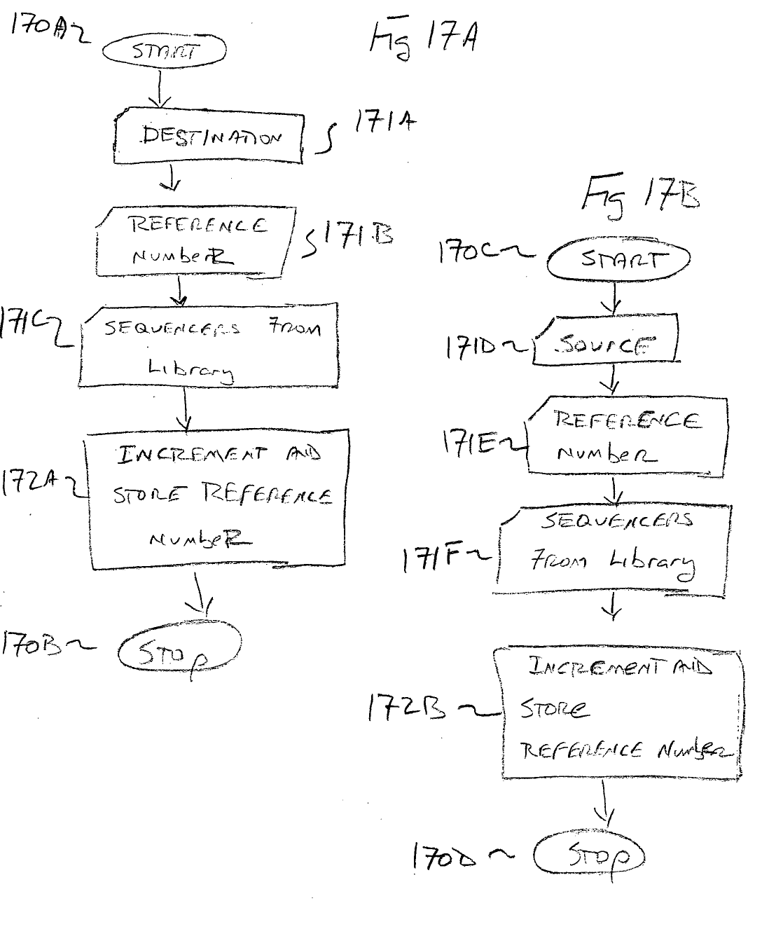

FIGS. 17A and 17B are flowcharts illustrating an embodiment of the invention used to change the parameters used between a transmitting party and a receiving party.

Referring to FIG. 17A, a flowchart used to adjust the selection of the sequence generators between two parties, after start 170A, the destination for the message is obtained 171B. The destination is used to establish which reference number is used 171B and the sequence generators from the library of sequence generators is obtained 171C. These sequence generators are used as outlined above for the encryption of the message as well as the creation of the red herrings described above.

The reference number is then incremented/adjusted using a sequence generator chosen for this purpose and the new reference number is stored for later use as outlined above 172A. The program then stops 170B.

FIG. 17B shows how a receiving computer keeps track of the proper sequence generators from a particular source.

Once the program starts 170C, the source of the message is obtained 171D. The source information is used to obtain the proper reference number 171E from memory and is used to obtain the sequence generators from the library 171F.

The reference number is then incremented/adjusted using a sequence generator which is identical to the sequence generator described in FIG. 17A used for the purpose of adjusting the reference number, this new adjusted reference number is stored for later use as outlined above 172B. The program then stops 170D.

In this manner, the two computers stay is step with each other so that messages are properly encrypted and decrypted. Should an interloper purloin a message, then the two computers become “out of step” and subsequent messages are scrambled because they will not be properly decrypted. This alerts the receiver that something is amiss and proper attention to the system can be applied.

Using the technique above, the present invention provides for a highly personalized, secure, and efficient communication channel.

What is claimed is:

1. A computer programmed to:
a) receive a message to be encrypted;
b) use a first sequence generator, to place false information within a template;
c) based upon said message, use a second sequence generator, to generate an encrypted text; and,
d) weave said encrypted text into said template among said false information.

2. The computer according to claim 1, wherein said computer is programmed to use a third sequence generator to establish the false information.

3. The computer according to claim 1, wherein said computer is programmed to choose said first sequence generator and said second sequence generator from a library of sequence generators.

4. The computer according to claim 3,
a) wherein said computer is programmed to receive a destination address for communicating said template to a remote computer; and,
b) wherein said first sequence generator and said second sequence generator are chosen in response to said destination address.

5. The computer according to claim 4, wherein said computer is further programmed to:
a) create a modulation value; and,
b) use said modulation value in conjunction with said destination address for subsequent communications with said remote computer.

6. The computer according to claim 4, programmed to:
a) receive a first user generated key; and,
b) use said first user generated key with said first sequence generator.

7. The computer according to claim 5, programmed to use said first user generated key with said second sequence generator.

8. An encryption method comprising the steps of:
a) scattering a series of false symbols within a template; and,
b) interweaving, among said series of false symbols within said template, a series of true symbols.

9. The encryption method according to claim 8, further comprising the step of creating said series of true symbols by encrypting an original series of symbols.

10. The encryption method according to claim 9, further comprising the step of placing said series of false symbols within said template using a sequence generator.

11. The encryption method according to claim 8, further comprising the step of scattering a second series of false symbols within said template before the step of interweaving the series of true symbols.

12. The encryption method according to claim 10, further including the step of creating the series of false symbols using a second sequence generator.

13. A communication computer programmed to:
a) receive a message to be encrypted;
b) use a first sequence generator, to establish locations for false information; and,
c) based upon a chosen character within said message, use a second sequence generator to generate an encrypted character; and,
d) selectively communicate either false information or said encrypted character to a remote computer.

14. The communication computer according to claim 15, wherein said communication computer is programmed to choose said first sequence generator and said second sequence generator from a library of sequence generators.

15. The communication computer according to claim 14,
a) wherein said communication computer is programmed to receive a destination address; and,
b) wherein said first sequence generator and said second sequence generator are chosen in response to said destination address.

16. The communication computer according to claim 15, programmed to:
a) receive a first user generated key; and,
b) use said first user generated key to establish locations of false information.

17. An encryption and communication method comprising the steps of:
a) creating a series of false symbols having defined locations within a message; and,
b) based upon a position within said message being sent and said defined locations, selectively communicating to a remote computer either a false symbol or a true symbol.

18. The encryption and communication method according to claim 17, further including the step of establishing said true symbol using a first predefined sequence generator.

19. The encryption and communication method according to claim 18, further including the step of accepting a first user defined key used to initiate said first predefined sequence generator.

20. The encryption and communication method according to claim 19, further including the step of establishing said defined locations using a second predefined sequence generator.

21. The encryption and communication method according to claim 20, further including the step of accepting a second user defined key used to initiate said second predefined sequence generator.

22. The encryption and communication method according to claim 20, further including the step of establishing said true symbol using a third predefined sequence generator.

23. The encryption and communication method according to claim 22, further including the step of accepting a third user defined key used to initiate said third predefined sequence generator.

24. A computer programmed to communicate a message to a remote computer, said message having both true encrypted characters and false encrypted characters intermixed therewith.

25. The computer according to claim 24, programmed to:
a) encrypt said true encrypted characters using a first sequence generator; and,
b) place said false encrypted characters using a second sequence generator.
